(19) United States
(12) Patent Application Publication
(10) Pub. No.: US 2021/0284870 A1
(43) Pub. Date: Sep. 16, 2021

(54) Self Adhesive Protective Floor Paper

(71) Applicant: T. Michael Greer, Spartanburg, SC (US)

(72) Inventor: T. Michael Greer, Spartanburg, SC (US)

(21) Appl. No.: 17/199,749

(22) Filed: Mar. 12, 2021

Related U.S. Application Data
(60) Provisional application No. 62/988,407, filed on Mar. 12, 2020.

(51) Int. Cl. C09J 7/21

(52) U.S. Cl. CPC C09J 7/21; C09J 2400/283; C09J 2203/37

(57) ABSTRACT

A repositionable self-adhesive protective paper configured to protect the valuable surface during building processes is disclosed. The protective paper uses a protection material such as sturdy paper to protect the surface. The surface could be floors, walls, and countertops. The protective paper has a top surface and a bottom surface. The bottom surface is coated with an adhesive layer on at least two edges. The adhesive layer is configured to easily adhere and remain the protective paper in place. Further, the protective paper uses one or more strips of tape to secure the non-adhesive edges to the surface. After completing the building processes, the adhesive layers are removed from the protected surface without any residues or damages.

### BACKGROUND OF THE INVENTION

### A. Technical Field

The present invention generally relates to surface coverings. More particularly, the present invention relates to surface coverings incorporating one or more adhesive layers to provide a slip resistant layer of protection to most surfaces.

### B. Description of Related Art

Conventionally, several types of floor laying materials such as ceramic tile, wooden flooring, laminate flooring, vinyl composite tile, epoxy, concrete, linoleum, and most other types are available in the market. The floor laying materials are utilized to cover the surfaces such as floors, walls, and countertops in public and commercial places. The floors and countertops are installed before completing the construction process. The cabinets, trims, and various other installations are placed after installing the floors.

During construction and installation processes, the expensive surfaces could suffer from a variety of construction activities including tool damage, paint or adhesive spills and foot traffic. To avoid such damages, surfaces such as floors, walls, and countertops are required to be protected. Some of the common types of temporary floor protecting solutions include rosin papers and other plastic flooring films with glue. However, the existing floor protecting solutions have their own drawbacks. The rosin paper is not the best solution to use on its own and needs tape to hold in place.

Further, the plastic flooring film could be coated on one side with an adhesive layer. The adhesive on the plastic flooring film could sometimes be transferred to the floor. Removing the squeezed glue from the floor becomes an inconvenient and time-consuming process. In addition, some type of dry-cleaning solvent is required to remove the adhesive on the floor, yet it could damage the floor if not used carefully. Further, it could be slippery and inconvenient to use.

In light of the above-mentioned drawbacks, there is a need for a solution to provide a slip resistant layer of protection to most surfaces including flooring and countertops. Also, there is a need for a repositionable protective paper that protects the floor surface from being damaged during the construction, remodeling, and painting processes.

### SUMMARY OF THE INVENTION

The present invention generally discloses surface coverings. Further, the present invention discloses a repositionable self-adhesive protective paper or floor protecting film or surface covering panel (hereinafter referred as protective paper) incorporating one or more adhesive layers to provide a slip resistant layer of protection to most surfaces.

According to the present invention, the protective paper is an innovative and intelligent solution that has been designed to protect the valuable surface during building processes. In one embodiment, the protective paper uses a protection material such as sturdy paper to protect the surface. In some embodiments, the surface could be floors, walls, and countertops. In one embodiment, the protective paper protects damage from being inflicted on the installed surface during various building processes such as construction, remodeling, and painting processes.

In one embodiment, the protective paper has a top surface and a bottom surface. The bottom surface is coated with an adhesive layer. In one embodiment, the protective paper could be rectangular or square in shape. In one embodiment, at least two edges of the bottom surface are coated with the adhesive layers, whereas the other two edges are non-adhesive edges. In one embodiment, the adhesive layer is repositionable. In one embodiment, the adhesive layer is configured to easily adhere and remain in place. In one embodiment, the adhesive layer could be easily removed or released without any residues or damages to the protected surface. In one embodiment, the protective paper requires a strip of tape configured to secure the non-adhesive edges to the surface.

In one embodiment, the protective paper could be applied on the surfaces including, but not limited to, wood, tile, linoleum, or any hard floor surface as well as granite and composite countertop materials. In one embodiment, the protective paper is a cost-effective self-adhesive paper configured to provide a slip resistant layer of protection to the surfaces including floors, walls, and countertops during building processes. After completing the building process, the protective paper is released from the surface without leaving residue or damage. The protective paper can be applied to large and small areas to prevent damage to most surfaces needing protection.

In one embodiment, the protective paper is intended to protect the expensive finishes from damage caused by the factors such as foot traffic, tools, drywall application, construction adhesives, and most other construction or remodeling mishaps. In one embodiment, the protective paper is supplied in rolls that could be applied by flooring and countertop installers or construction workers. Further, the adhesive layers and the strip of tape at the edges are configured to secure the protective paper to the desired surface with superior adhesion and stability.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a repositionable self-adhesive protective paper applied on a surface in a typical use case in one embodiment of the present invention.

FIG. 2A shows a perspective view of the repositionable self-adhesive protective paper applied on the surface in one embodiment of the present invention.

FIG. 2B shows a perspective view of the repositionable self-adhesive protective paper applied on the surface in another embodiment of the present invention.

FIG. 2C shows a perspective view of the repositionable self-adhesive protective paper applied on the surface in yet another embodiment of the present invention.

FIG. 3 shows a sheet of repositionable self-adhesive protective paper with pre-applied adhesive layers in one embodiment of the present invention.

FIG. 4 shows various sizes of the repositionable self-adhesive protective paper in different embodiments of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

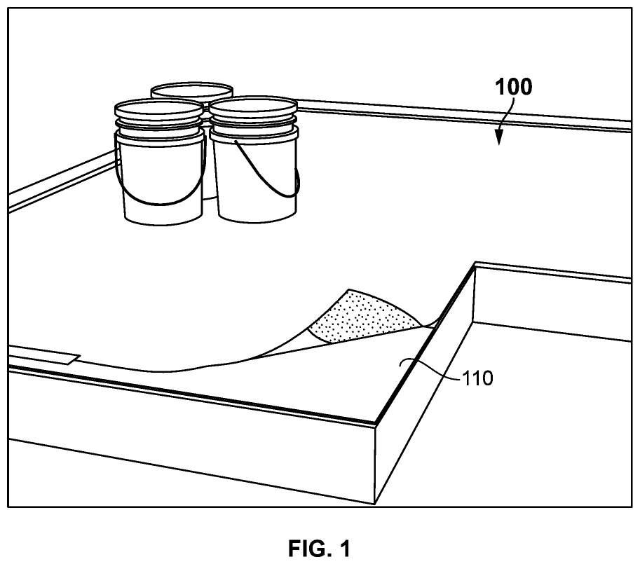

Referring to FIG. 1, a repositionable self-adhesive protective paper or floor protecting film or surface covering panel (hereinafter referred as protective paper) 100 applied on a surface 110 in a typical use case, according to one embodiment of the present invention. The protective paper 100 is an innovative and intelligent solution that has been designed to protect the valuable surface 110 during building processes. In one embodiment, the protective paper 100 uses a protection material such as sturdy paper to protect the surface 110. In some embodiments, the surface 110 could be floors, walls, and countertops. In one embodiment, the protective paper 100 protects damage from being inflicted on the installed surface 110 during various building processes such as construction, remodeling, and painting processes.

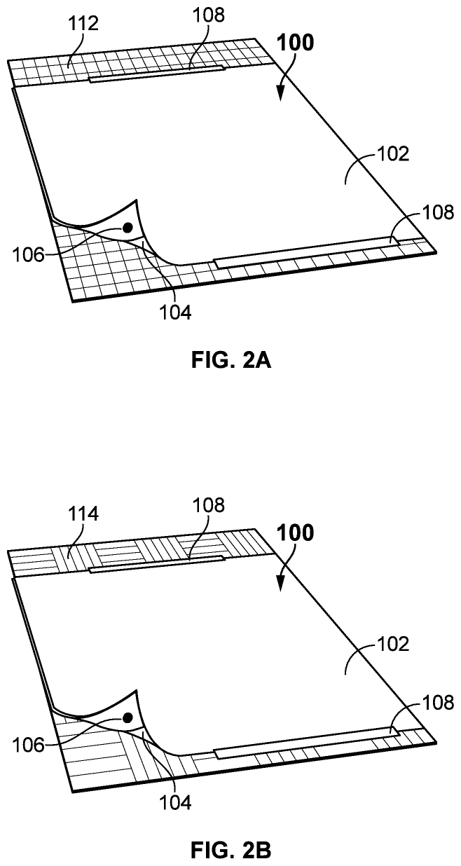

Referring to FIGS. 2A-2C, the protective paper 100 applied on different surfaces, according to various embodiments of the present invention. In one embodiment, the protective paper 100 could be applied on the surfaces 110 made of wood, tile, linoleum, or any hard floor surface as well as granite and composite countertop materials. FIG. 2A illustrates the protective paper 100 applied to the large areas of tiles 112, according to one embodiment of the present invention. FIG. 2B illustrates the protective paper 100 applied to the large areas of wooden surface 114, according to another embodiment of the present invention. FIG. 2C illustrates the protective paper 100 applied to the large areas of linoleum surface 116, according to yet another embodiment of the present invention. The protective paper 100 can be applied to large and small areas to prevent damage to most surfaces needing protection.

In one embodiment, the protective paper 100 has a top surface 102 and a bottom surface 104. The bottom surface 104 is coated with an adhesive layer 106. In one embodiment, the protective paper 100 could be rectangular or square in shape. In one embodiment, at least two edges of the bottom surface 104 are coated with the adhesive layers 106, whereas the other two edges are non-adhesive edges. In one embodiment, the adhesive layer 106 is repositionable. In one embodiment, the adhesive layer 106 is configured to easily adhere and remain the protective paper 100 in place. In one embodiment, adhesive layer 106 could be easily removed or released without any residues or damages to the protected surface 110. In one embodiment, the protective paper 100 requires one or more strips of tape 108 configured to secure the non-adhesive edges to the surface (112, 114, and 116). In one embodiment, the protective paper 100 is intended to protect the expensive finishes from damage caused by the factors such as foot traffic, tools, drywall application, construction adhesives, and most other construction or remodeling mishaps.

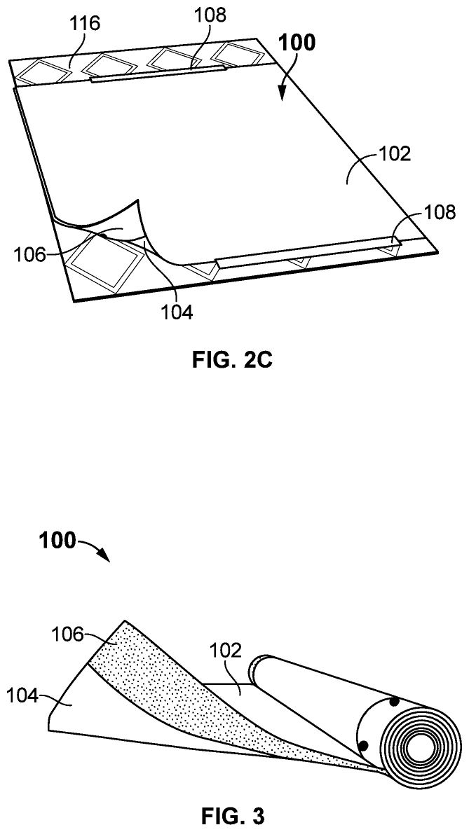

Referring to FIG. 3, a sheet of protective paper 100 with pre-applied adhesive layers 106, according to one embodiment of the present invention. In one embodiment, the protective paper 100 has the top surface 102 and bottom surface 104. The bottom surface 104 is coated with the adhesive layer 106. In one embodiment, at least two edges of the bottom surface 104 are coated with the adhesive layers 106, whereas the other two edges are non-adhesive edges. In one embodiment, the adhesive layer 106 is repositionable. In one embodiment, the adhesive layers 106 enable easy repositioning of the protective paper 100. The repositionable adhesive layer 106 could be easily removed without any damage or residue.

In one embodiment, the adhesive layer 106 has the added benefit of reapplication, which enables the protective paper 100 to be easily released from the protected surface 110. In one embodiment, the protective paper 100 is a cost-effective self-adhesive paper configured to provide a slip resistant layer of protection to the surfaces 110 including floors, walls, and countertops during building processes. After completing the building process, the protective paper 100 is released from surface 110 without leaving residue or damage.

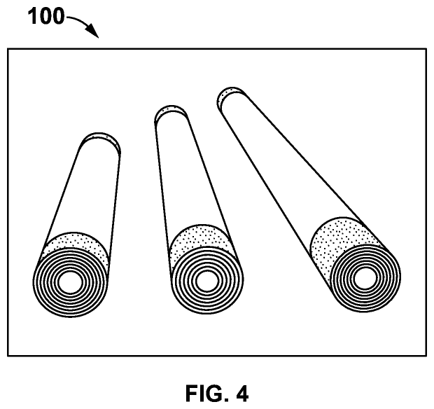

Referring to FIG. 4, various size configurations of the protective paper 100, according to different embodiments of the present invention. In one embodiment, the protective paper 100 is supplied in rolls that could be applied by flooring and countertop installers or construction workers. In one embodiment, the adhesive layer 106 of the protective paper 100 is supplied without a release line, which enables the user to just roll out the protective paper 100 on the surface to be protected. The protective paper 100 is designed in various sizes to use with different sizes of floor surfaces 110. In one embodiment, the rolls of protective paper 100 could be supplied with various widths and thicknesses to meet the individual protection requirements. In one embodiment, the protective paper 100 could range from 304.8 millimeters to 1829 millimeters. The adhesive layers 106 and the strip of tape 108 at the edges are configured to secure the protective paper 100 to the desired surface 110 with superior adhesion and stability.

Advantageously, the protective paper could be directly applied to most surfaces such as flooring, countertops, and even glass. The protective paper prevents surfaces from scuffing, scratches, and other damages. The protective paper could be easily removed and eliminates expensive repair or replacement after completing the building processes. The protective paper saves time and money required to prevent the floor damage and surfaces vulnerable to damage during building processes such as construction or remodeling. Further, the protective paper could be supplied in various colors to increase the market interest. The user benefits from the improved protective paper, which could provide considerable market interest in the product.

Preferred embodiments of this invention are described herein, including the best method known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1) A protective cover to protect a surface, comprising;
a top surface;
a bottom surface opposing the top surface and being coated with an adhesive layer;
wherein the protective cover is formed from a production material. In one embodiment, the protective paper uses a protection material such as sturdy paper to protect the surface.

2) A protective cover to protect a surface as in claim 1, wherein the surface is a floor.

3) A protective cover to protect a surface as in claim 1, wherein the surfaces the wall.

4) A protective cover to protect a surface as in claim 1, wherein the surface is a countertop.

5) A protective cover to protect a surface as in claim 1, wherein the production material is paper;

6) A protective cover to protect a surface as in claim 1, wherein the protective cover is rectangular in shape.

7) A protective cover to protect a surface as in claim 1, wherein the protective cover is square in shape.

8) A protective cover to protect a surface as in claim 1, wherein the protective cover includes two edges with adhesive and two edges without adhesive.

9) A protective cover to protect a surface as in claim 8, wherein the adhesive layer is reusable.

10) A protective cover to protect a surface as in claim 8, wherein the adhesive layer is configured to be released from the surface without residue.

11) A protective cover to protect a surface as in claim 8, wherein the two edges without adhesive includes tape.

12) A protective cover to protect a surface as in claim 11, wherein the adhesive is configured to attach to at least one of wood, tile, linoleum, granite and composite countertop materials.

13) A protective cover to protect a surface as in claim 1, wherein the top surface includes a slip resistant layer.

14) A protective cover to protect a surface as in claim 8, wherein the adhesive is a rear re-applicable.

15) A protective cover to protect a surface as in claim 1, wherein the protective cover is without a release line.
